(19) United States
(12) Patent Application Publication
(10) Pub. No.: US 2025/0346467 A1
(43) Pub. Date: Nov. 13, 2025

(54) MATERIAL HANDLING LIFT

(71) Applicant: Southworth International Group, Inc., Falmouth, ME (US)

(72) Inventors: Emmanuel Marsh-Sachs, Sidney, ME (US); Scott Stoddard, Gorham, ME (US); Jonathan Graeme Robertson, Biddeford, ME (US)

(21) Appl. No.: 19/206,633

(22) Filed: May 13, 2025

Related U.S. Application Data
(60) Provisional application No. 63/646,207, filed on May 13, 2024.
(60) Provisional application No. 63/748,220, filed on Jan. 22, 2025.

(51) Int. Cl. B66F 7/28

(52) U.S. Cl. CPC B66F 7/28

(57) ABSTRACT

A material handling lift including: a mast; a platform coupled to the mast; and a power unit configured to drive the platform along the mast to a raised position and lower the platform to a lowered position. The platform may pivot relative to the mast when it is raised to the raised position to retain a cart on the platform by force of gravity. The mast may be coupled to the platform with a non-zero angle between the front of the mast and a rear of the platform. Optical sensors may dynamically establish raised and lowered safety zones around the platform.

### CROSS-REFERENCE TO RELATED APPLICATIONS

The present application claims the benefit of the filing dates of U.S. Provisional Application Ser. No. 63/646,207, filed May 13, 2024, and U.S. Provisional Application Ser. No. 63/748,220, filed Jan. 22, 2025, the entire teachings of which are hereby incorporated herein by reference.

### FIELD

The present disclosure relates to lifts, and, more particularly, to a material handling lift.

### BACKGROUND

A wide variety of material handling lifts are well known. In general, material handling lifts may transfer materials and/or people from one position to another position, e.g., by vertically lifting the material, moving the material horizontally, rotating and/or lifting the material, etc. For example, a vertical lift may be configured as a roll-on lift configured with a platform that moves between lowered and raised positions, e.g., using hydraulic or electric power. When the platform is in the lowered position, a user may move one or more pallets or other containers onto the platform and then energize the lift to raise the platform and the pallet thereon to the raised position. The user may then roll the pallets or other containers off the platform.

### BRIEF DESCRIPTION OF THE DRAWINGS

For a better understanding of the present invention, together with other objects, features and advantages, reference should be made to the following detailed description which should be read in conjunction with the accompanying figures, wherein:

FIG. 1 is top perspective view of one example of a prior art vertical lift with a platform in a lowered position.

FIG. 2 is a top perspective view of the vertical lift shown in FIG. 1 with the platform in a raised position.

FIG. 3 is a top perspective view of at least a portion of a vertical lift consistent with the present disclosure with a platform in a lowered position.

FIG. 4 is a close-up view of a portion of the platform of the vertical lift shown in FIG. 3.

FIG. 5 is a top perspective view of the lift shown in FIG. 3, with the platform in a lowered position and a roller cart disposed on the platform.

FIG. 6 is a top perspective view of the lift shown in FIG. 5, with the platform in a raised position.

FIG. 7 is a top perspective view of the lift shown in FIG. 3, with the platform in a lowered position and a pallet disposed on the platform.

FIG. 8 is a top perspective view of the lift shown in FIG. 7, with the platform in a raised position.

FIG. 9A is a left side perspective view of another example vertical lift consistent with the present disclosure with a platform in a lowered position.

FIG. 9B is a top view of the vertical lift shown in FIG. 3.

FIG. 9C is a right side perspective view of the lift shown in FIG. 9A.

FIG. 9A is a rear view of the lift shown in FIG. 9A.

FIG. 10A is a left side perspective view the vertical lift shown in FIG. 9A with a cart disposed on the platform.

FIG. 10B is a top view of the vertical lift and cart shown in FIG. 10A.

FIG. 10C is a sectional view of the vertical lift shown in FIG. 10A showing the positioning of the platform and the cart when the lift is in the lowered position.

FIG. 10D is a magnified view of a portion of the vertical lift and the cart shown in FIG. 10C.

FIG. 11A is a perspective view of the platform of the vertical lift shown in FIG. 9A.

FIG. 11B is a rear view of the platform shown in FIG. 11A.

FIG. 11C is top view of the platform shown in FIG. 11A.

FIG. 11D is a left side view of the platform shown in FIG. 11A.

FIG. 11E is a sectional view of the platform shown in FIG. 11A.

FIG. 12 is a sectional view of the vertical lift shown in FIG. 10A showing the positioning of the platform and the cart when the lift is in the raised position.

FIG. 13A is a perspective view of another example embodiment of a platform useful in a lift consistent with the present disclosure.

FIG. 13B is a perspective sectional view of the platform shown in FIG. 13A.

FIG. 14 is a perspective view of another embodiment of a vertical lift consistent with the present disclosure showing protection zones.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

In general, a material handling lift consistent with the present disclosure includes a mast, a platform coupled to the mast, and a power unit configured to drive the platform along the mast to a raised position and lower the platform to a lowered position. In some embodiments, the platform may pivot relative to the mast when it is raised to the raised position to retain a cart on the platform by force of gravity. In some embodiments, the mast may be coupled to the platform with a non-zero angle between the front of the mast and a rear of the platform. In some embodiments, optical sensors may dynamically establish raised and lowered safety zones around the platform. In some embodiments, the platform may include one or more features, e.g., one or more slots ramps, and/or openings in the top surface thereof, for receiving the cart and holding the cart in a stable position on the platform while the platform moves from a lowered position to a raised position.

In some embodiments, the lift may be modular and may and the mast may be configured for coupling to different platforms and/or frame members to allow for different platform configurations and/or sizes to be used with the same mast configuration. For example, a non-rotating platform may be exchanged for a rotating turn-table-type platform, different sizes of platforms may be used, and/or different configurations of features for receiving a pallet and/or a roller may be used.

For ease of explanation only, a lift consistent with the present disclosure is described may be described in connection with a particular configuration. It is to be understood, however, that a lift consistent with the present disclosure may be provided in any lift configuration, e.g., in a front-entry vertical lift configuration, in a side-entry vertical lift configuration, in a lift configuration without sides, in a lift configuration that moves materials in a horizontal or angular direction, in a lift configuration that rotates materials, etc. The example embodiments shown and described herein are thus provided by way of illustration, not limitation.

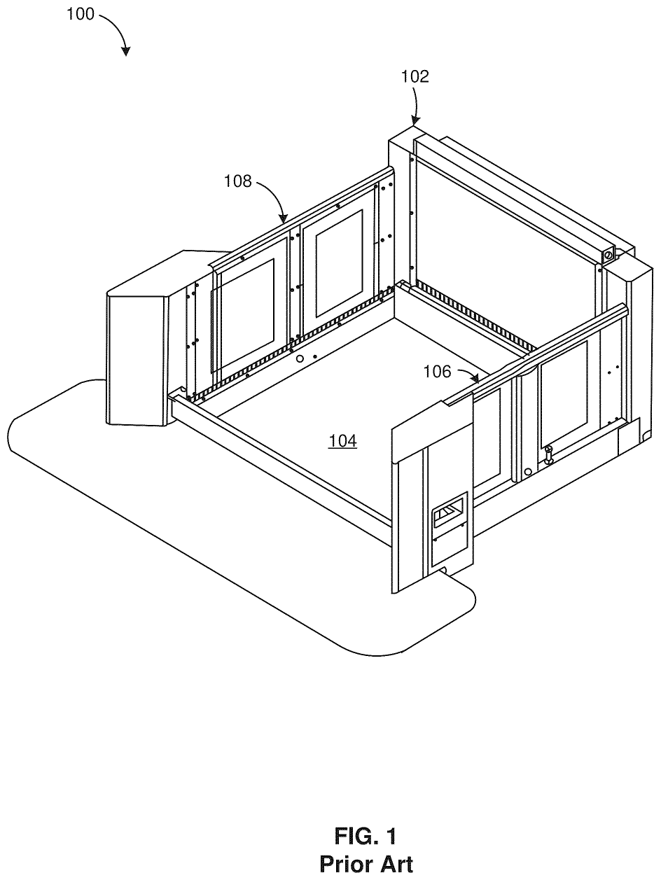

FIG. 1 shows an example embodiment of a prior art lift 100 consistent with the present disclosure. The lift 100 is described in U.S. Patent Application Publication No. 2023/0227296 (hereinafter “the '296 application”) the entire teachings of which are hereby incorporated herein by reference. In general, the lift 100 includes a mast 102, a platform 104, a right side guard panel 106, and a left side guard panel 108. When the lift 100 is assembled, the lift 100 forms a rigid free-standing structure.

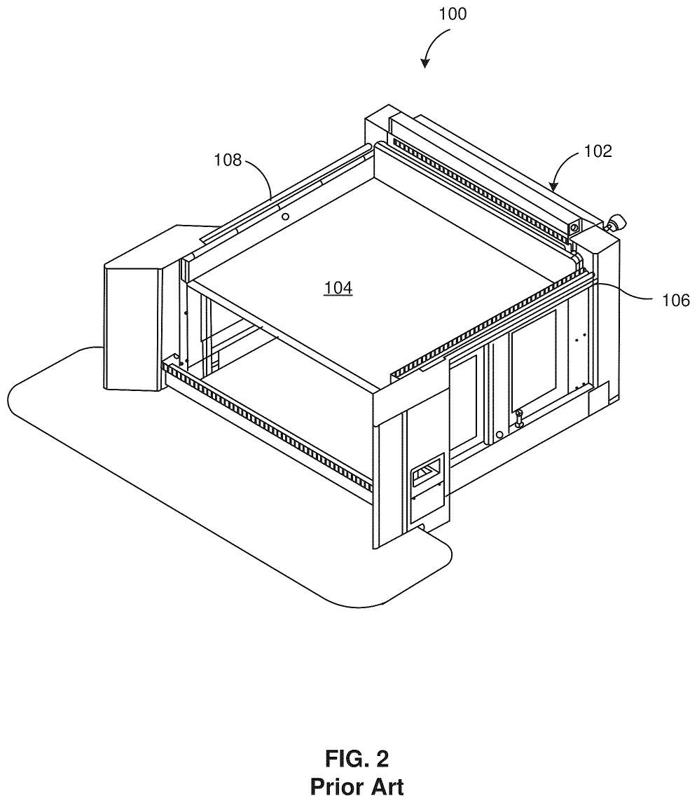

In the illustrated example, a front side of the lift 100 is open to allow access to the platform 104 for loading and unloading material onto/from the platform 104, although any one or more sides of the lift may be open to allow access for loading and unloading depending on the application. The mast 102 houses a power unit that uses hydraulic or electric power for driving a platform 104 from a lowered position, as shown in FIG. 1 to a raised position as shown in FIG. 2. A user may selectively control operation of the power unit by operation of user controls placed on the exterior of the lift 100, e.g., on one of the side guard panels 106, 108, to place the platform 104 and any materials loaded thereon in the lowered position or the raised position.

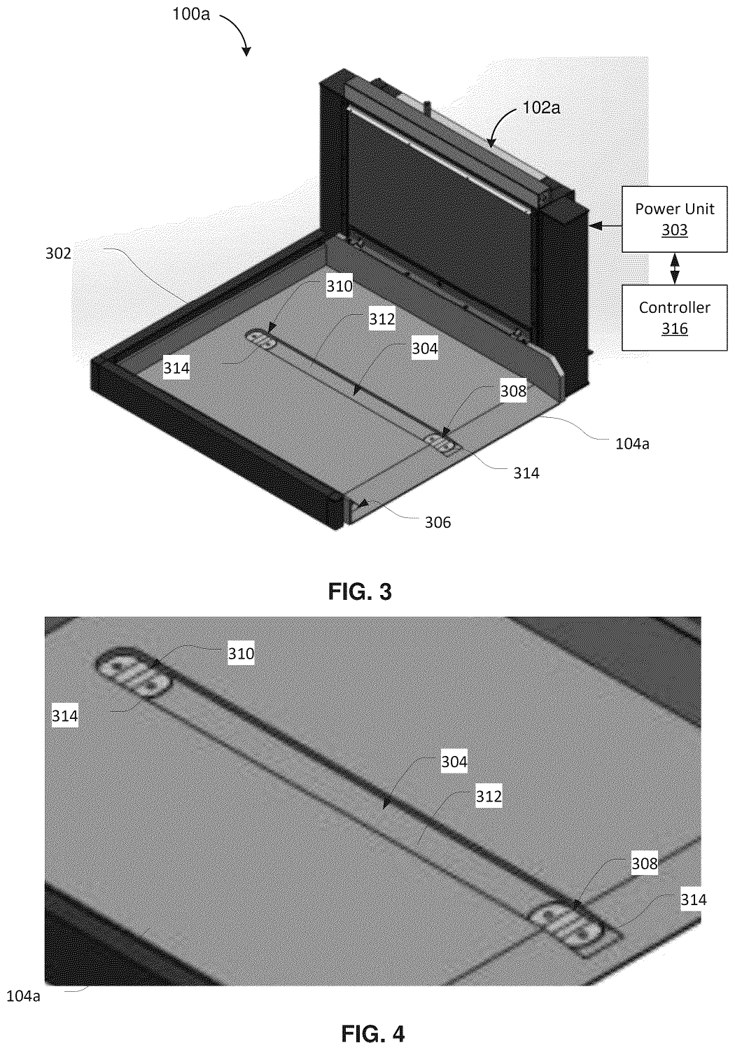

FIG. 3 illustrates one example embodiment of a lift 100a consistent with the present disclosure. The lift 100a includes a mast 102a, a platform 104a and a frame 302. In the illustrated example, the frame 302 extends around the left and front sides of the lift 100a, the mast 102a forms a rear side of the lift 100a, and the right side of the lift 100a is open to allow access to the platform 104a for loading and unloading material onto/from the platform 104a, although any one or more sides of the lift 100a may be open to allow access for loading and unloading depending on the application. The mast 102a houses a power unit 303 that uses hydraulic or electric power for driving a platform 104a from a lowered position to a raised position, as described for example in the '296 application. A user may selectively control operation of the power unit by operation of user controls placed on the exterior of the lift 100a to place the platform 104a and any materials loaded thereon in the lowered position or the raised position.

One or more features for receiving a roller cart may be provided in the platform 104a in a variety of configurations. In some embodiments, the one or more features includes a slot and/or a hole in the platform 104a. In the illustrated example embodiment, the platform 104a includes an inner slot 304 extending parallel to the direction of entry, i.e., in the direction from the right of the lift 100a to the left of the lift 100a in FIG. 3. A corresponding outer slot 306 may be positioned along the front side of the lift 100a parallel to the frame 302. The inner and outer slots 304, 306 may extend from a ramp of the platform 104a at the right of the lift 100a toward the left side of the lift 100a by a distance equal to or greater than a longitudinal distance between wheels of a roller cart intended to be lifted by the lift 100a. The linear distance between a centerline of the inner slot 304 and the outer slot 306 in the direction from the front to the rear of the lift 100a may be equal to or greater than the distance between the centerlines of the wheels intended to be lifted by the lift 100a measured across the length of the roller cart. The inner and outer slots 304, 306 may be formed in the top surface of the platform 104a but may not extend therethrough. The slots may thus guide the wheels of the roller cart as the roller cart is moved onto the platform 104a from the right side of the lift 100a to the left side of the lift 100a.

In the illustrated example embodiment, the inner and outer slots 304, 306 may include first 308 and second wheel 310 receptacles at the ends thereof. The inner slot 304 in FIG. 3 is shown in greater detail in FIG. 4. As shown in FIG. 4, the first and second wheel receptacles 308, 310 may extend through the platform 104a to form a hole from a top surface 312 of the slot 304 through the bottom surface of the platform 104a. In some embodiments, however, one or more of the first and second wheel receptacles 308, 310 may be configured as a slot formed in the top surface 312 of the inner or outer slots 304, 306.

The first and second wheel receptacles 308, 310 may be sized and shaped to receive associated wheels of the roller cart and releasably capture the wheels so that the roller cart is held in a stable position and restrict it from rolling on the platform 104a while the platform 104a is moved to the raised position. For example, when the first and second wheel receptacles 308, 310 are formed as holes, as the platform 104a is moved upwardly, the wheels may drop into the holes and, in some embodiments, a portion of the wheels may extend below the bottom surface of the platform 104a. The wheels may thus be releasably trapped in the wheel receptacles 308, 310 as the platform 104a is moved to the raised position.

One or more sensors 314, e.g., pressure sensors, strain sensors, Hall sensors, optical sensors, etc., may be placed under or near the first and second wheel receptacles 308, 310 to detect presence of the wheel of a cart. The sensors 314 may be configured to provide a first output when the a wheel is in the associated wheel receptacle 308, 310 and a second output when a wheel are not in the associated wheel receptacles 308, 310. These sensor outputs may be coupled to a controller 316, e.g., through a wired or wireless connection, for providing an operator with an indication as to whether the roller cart is properly positioned on the platform 104a and the platform 104a is ready to be raised. For example, if one sensor 314 indicates a wheel is in the associated wheel receptacle 308, 310 and an another sensor indicates a wheel is not in the associated wheel receptacle 308, 310, the roller cart may be misaligned on the platform 104a and the operator may be alerted, e.g. with an audible and/or visible signal, to properly align the cart prior to raising the platform 104a.

In some embodiments, the controller 316 may be coupled to a power unit to provide control signals to the power unit for enabling/preventing operation of the power unit depending on the sensor outputs For example, the control signals from the controller controller 316 may prevent operation of the lift 100a to raise the platform 104a if one sensor 314 indicates a wheel is in an associated wheel receptacle 308, 310 and another sensor 314 indicates a wheel is not in the associated wheel receptacle 308, 310. Similarly, the control signals from the controller may enable operation of the lift 100a to raise the platform 104a if all sensors 314 indicate a wheel is in an associated wheel receptacle 308, 310.

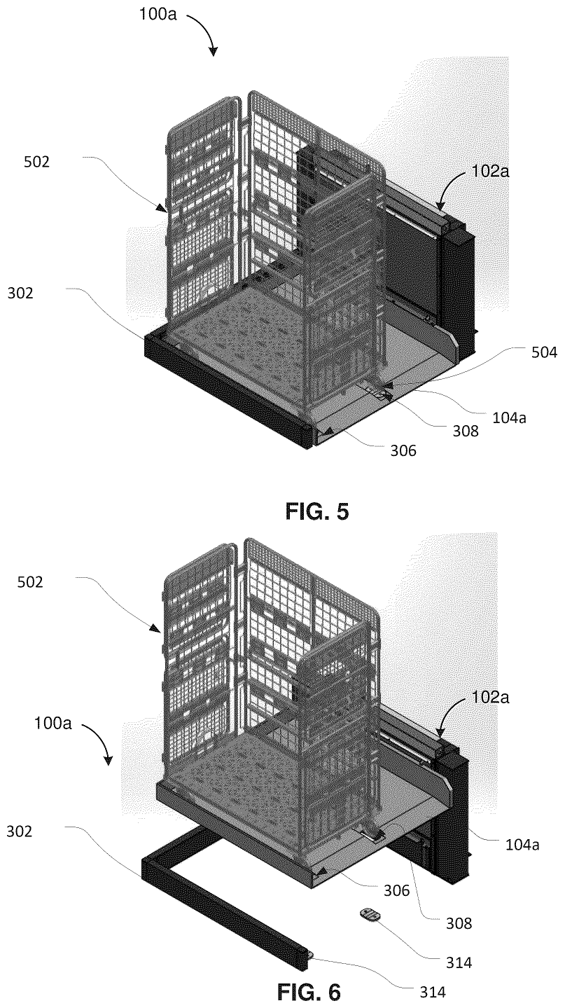

FIG. 5 is a top perspective view of the lift 100a shown in FIG. 3, with the platform 104a in a lowered position and a roller cart 502 disposed on the platform 104a, and FIG. 6 is a top perspective view of the lift 100a shown in FIG. 5, with the platform 104a in a raised position with the roller cart 502 disposed on the platform 104a. As shown in FIGS. 5 and 6, the wheels, e.g., wheel 504, of the roller cart 502 are disposed in in the inner and outer slots 304, 306 and within associated wheel receptacles 308, 310.

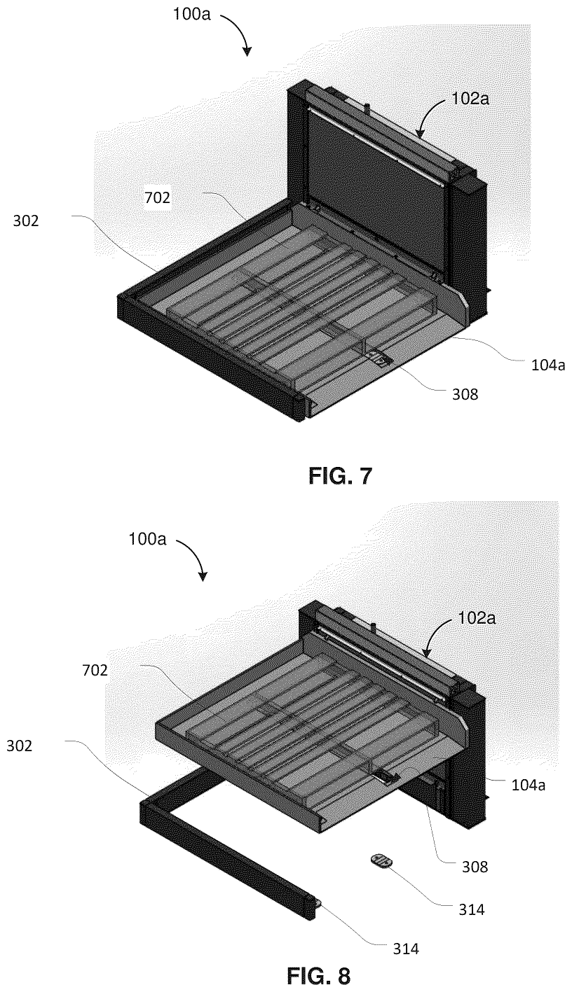

FIG. 7 is a top perspective view of the lift 100a shown in FIG. 3, with the platform 104a in a lowered position and a pallet 702 disposed on the platform 104a, and FIG. 8 is a top perspective view of the lift 100a shown in FIG. 7, with the platform 104a in a raised position with the pallet 702 disposed on the platform 104a. As shown in FIGS. 7 and 8, in some embodiments, the width of the platform 104a may be chosen to receive a pallet 702 having a specific maximum width. In some embodiments, for example, the pallet 702 may be a 1220 mm×1020 mm pallet, a 1200 mm×1000 mm pallet, a 1200 mm×800 mm pallet, etc.

In some embodiments, the lift 100a may be modular and the mast 102a may be configured for coupling to different platforms 104a and/or frame members to allow for different platform 104a configurations and/or sizes to be used with the same mast 102a configuration. For example, the a non-rotating platform 104a may be exchanged for a rotating turn-table-type platform 104a, different sizes of platforms may be used, and/or different configurations of features for receiving a pallet and/or a roller may be used.

In some embodiments, for example, the frame 302 may be removed and replaced by a frame defining a larger area for receiving a platform 104a to facilitate use of the lift 100a with a larger pallet 702, e.g. a 48″×48″ pallet, or with a turn-table platform for allowing rotational positioning of a pallet or roller cart on the platform.

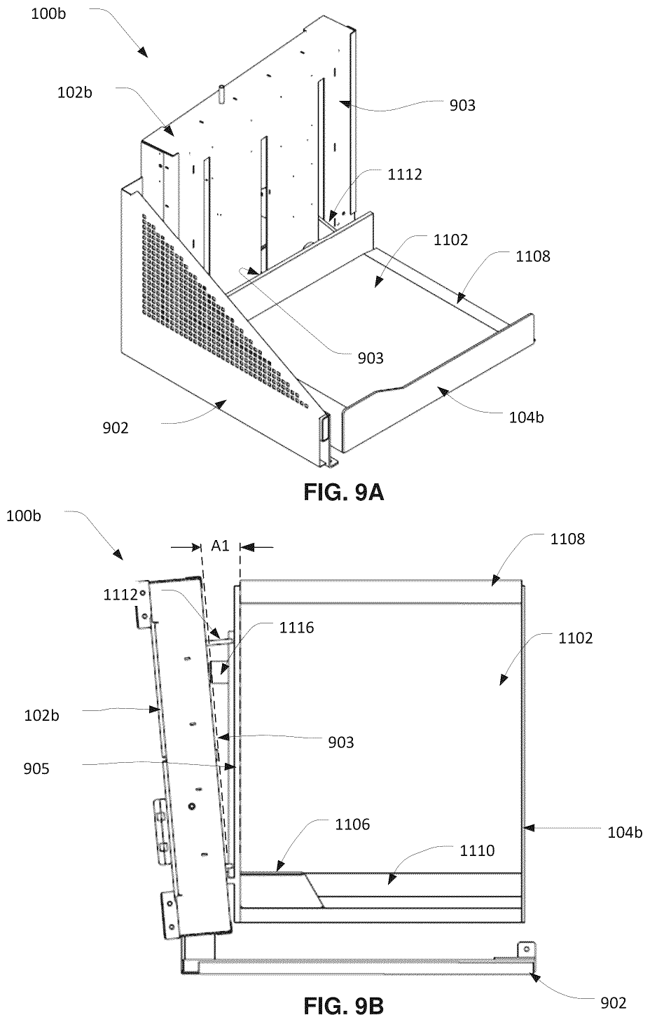

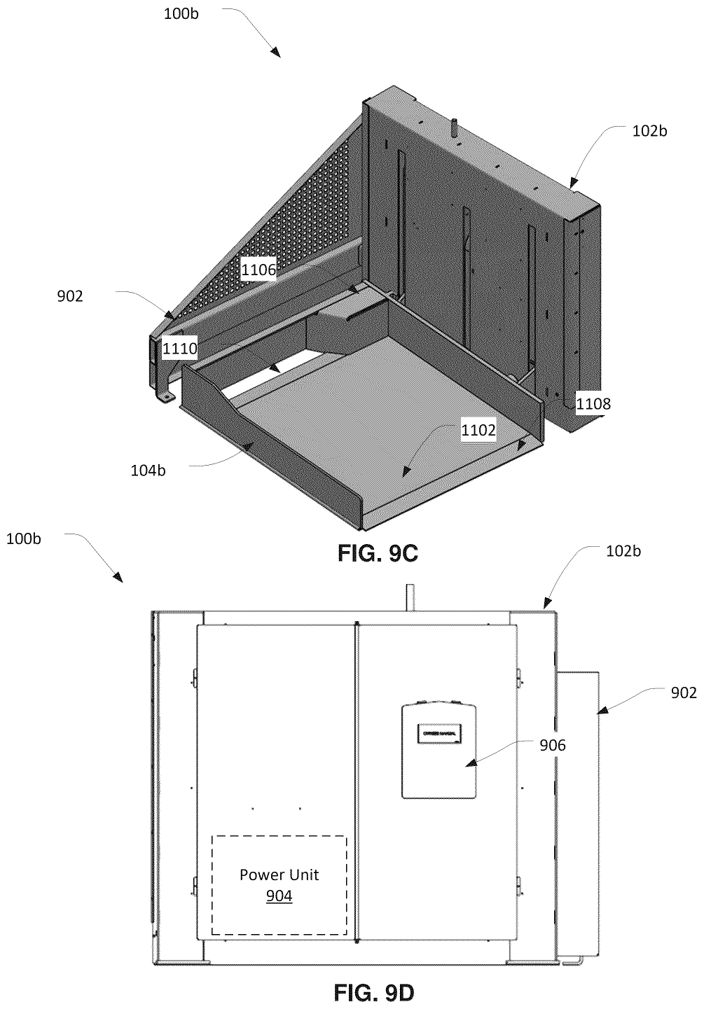

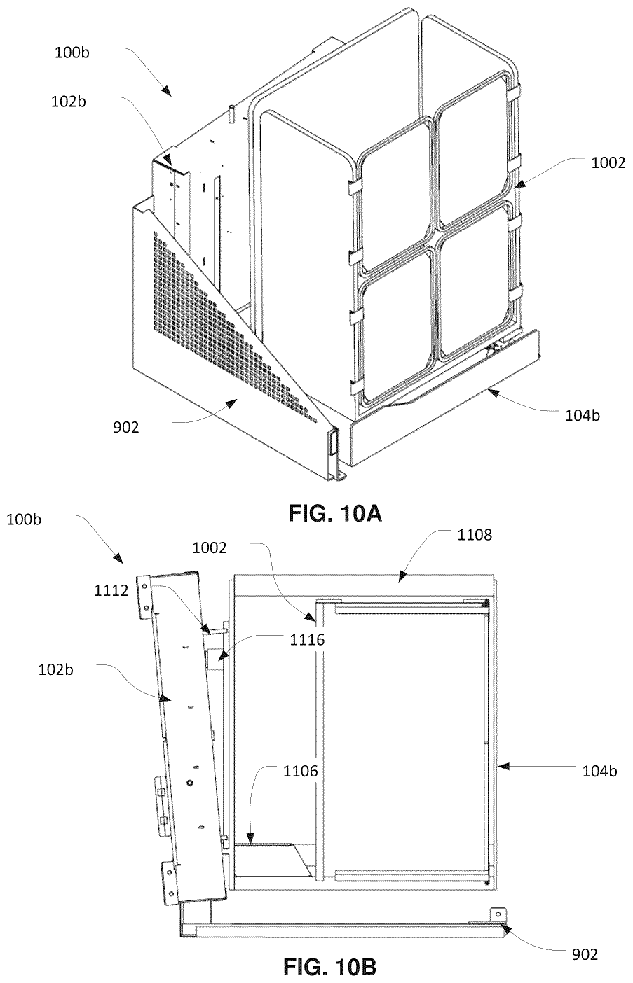

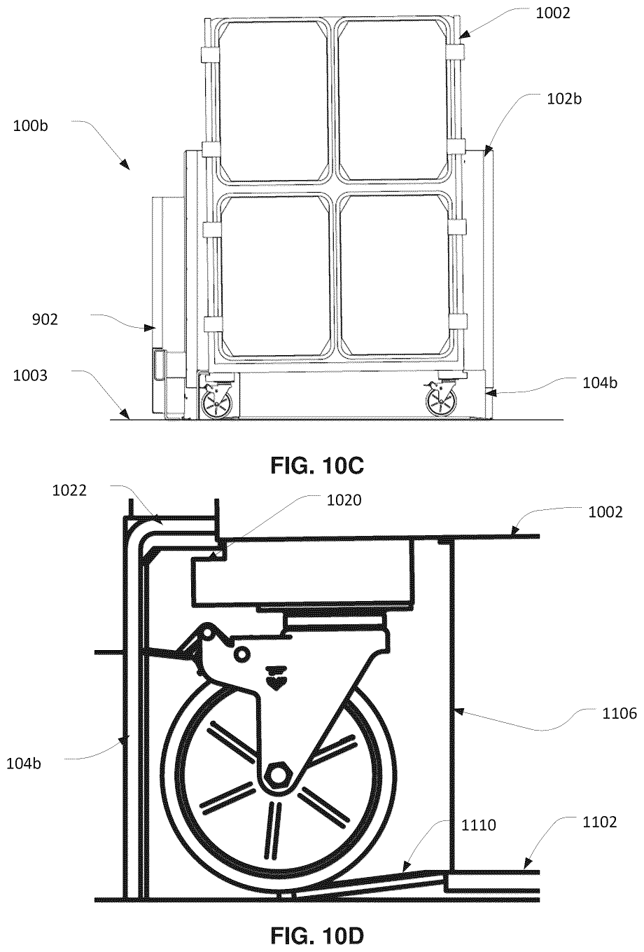

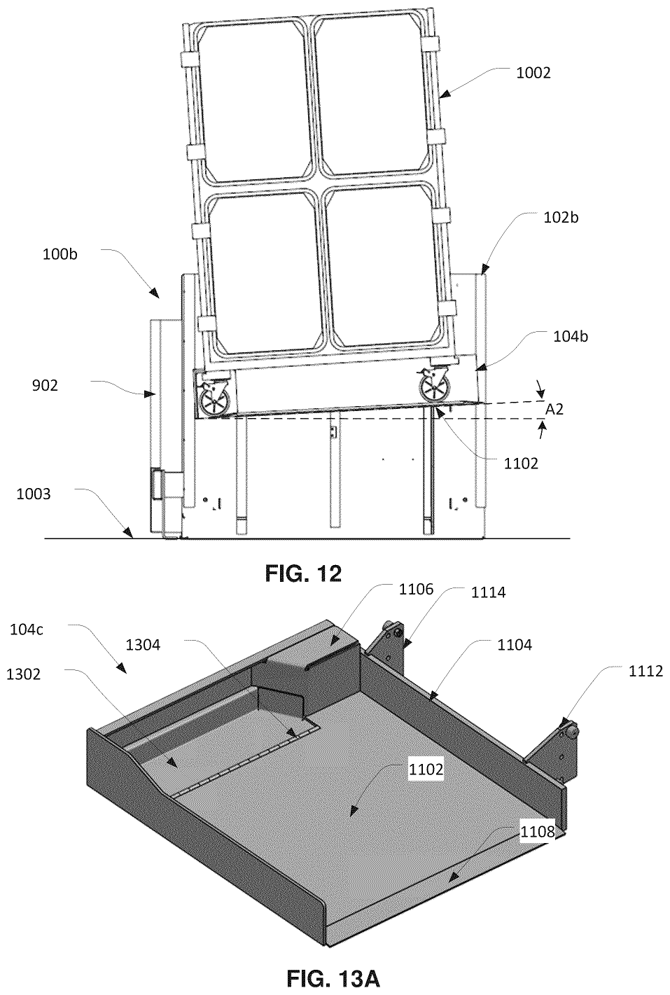

Another embodiment of a vertical lift 100b consistent with the present disclosure is shown in FIGS. 9A-9D, 10A-10D and FIG. 12. The lift 100b includes a mast 102b, a platform 104b and single support arm 902. The mast 102b forms a rear side of the lift 100b and houses a power unit 904 (FIG. 9D) that uses hydraulic and/or electric power for driving the platform 104b between a lowered position (e.g. as shown in FIG. 9A and FIG. 10C) and a raised position (e.g. as shown in FIG. 12) as described, for example, in the '296 application. A user may selectively control operation of the power unit 904 by operation of user controls 906 (FIG. 9D) placed on the exterior of the lift 100b to place the platform 104b and any materials loaded thereon in the lowered position or the raised position.

The support arm 902 is coupled to a side of the mast 102b and extends from the side of the mast 102b along only one side of the lift 100b, i.e., the left side in the illustrated example. No other support arm or structure extends from the mast 102b to support the mast 102b in the illustrated upright position. The right side and front of the lift 100b are open to allow access to the platform 104b. A wheeled cart 1002 (FIG. 10) may be loaded onto, or unloaded from, the platform 104b from the right side of the lift 100b. It is to be understood, however, that any one or more of the sides of the lift 100b and the platform 104b may be open to allow access for loading and unloading a cart 1002 onto the platform 104b depending on the application.

In the illustrated example embodiment, the front surface of the mast 102b is angularly disposed with respect to a rear of the platform 104b to allow facile access to the right side of the platform 104b for loading and unloading carts and other objects from the platform 104b. As shown particularly in the top view of FIG. 9B, the generally planar front surface 903 of the mast 102b is disposed at a non-zero angle A1 relative to the generally planar rear surface 905 of the platform 104b. The angle A1 depends on the application, and, in some cases, the dimensions of the mast 102b and the platform 104b and/or the configuration of the carts/loads to be lifted by the lift 100b. The angle A1 may be any angle that allows facile access to the right side of the platform 104b for loading and unloading carts and other objects. In some embodiments the angle A1 may nominally be between about 1 degree and 15 degrees.

In the illustrated example embodiment, the support 902 extends from the mast 102b and is positioned substantially in parallel with the left side of the platform 104b. In other embodiments, the support 902 may extend from the mast 102b to form a non-zero angle with respect to the left surface of the platform 104b.

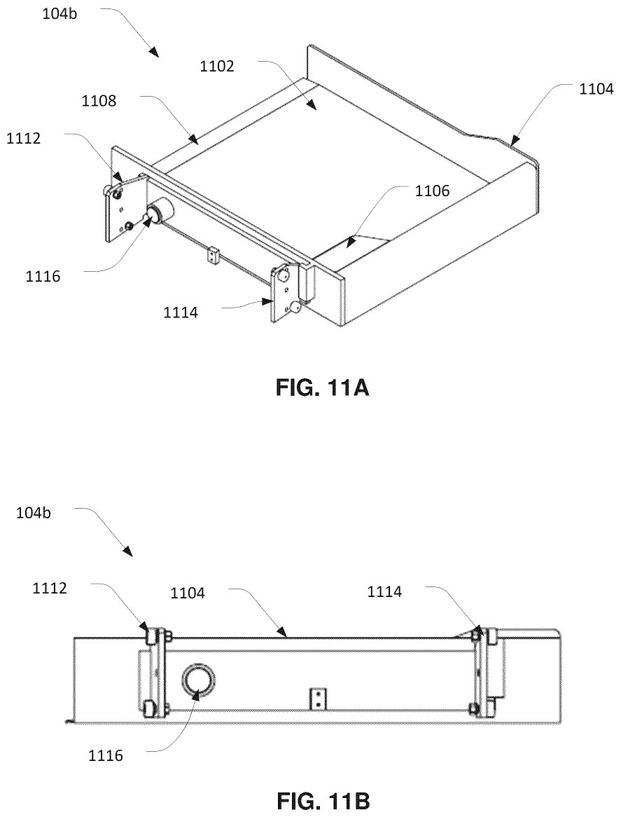

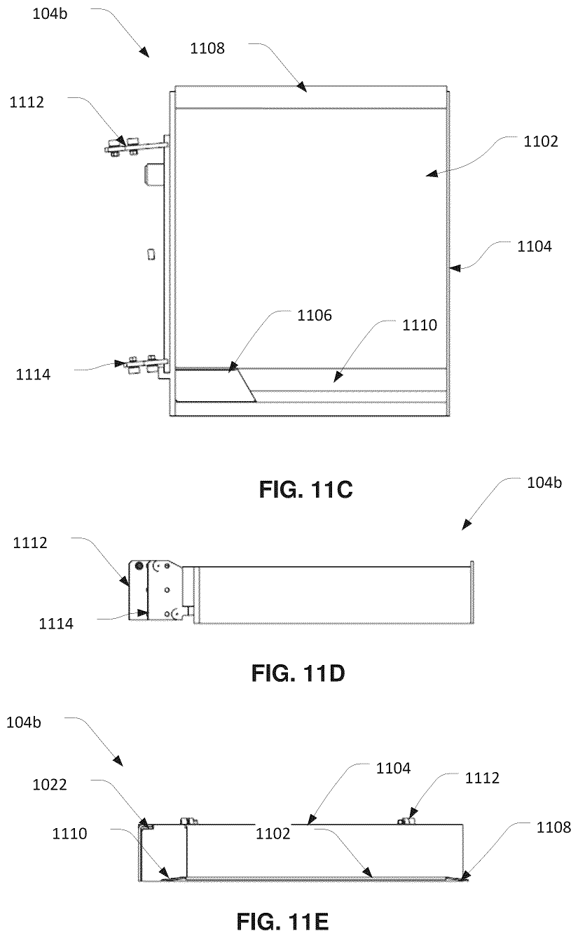

With reference also to FIGS. 11A-11E, the platform 104b includes a base 1102, a sidewall 1104 extending upward from the perimeter of the base 1102 around the front, left side, and rear of the platform 104b, a guide 1106, an entry ramp 1108, and a retention ramp 1110. The sidewall 1104 may not extend around the right side of the base 1102 to allow for a cart 1002 and/or other loads to be placed onto the base 1102 from the right side of the platform 104b. The entry ramp 1108 may extend downwardly from the right side of the base 1102 to allow a rolling cart 1002 to be rolled onto the base 1102 by passing over the entry ramp 1108. The retention ramp 1110 may be positioned adjacent the opposite side of the platform 104b compared to the entry ramp 1108, i.e., the left side in the illustrated embodiment, and may extend downwardly with respect to the base 1102.

A right side coupling arm 1112 and a left side coupling arm 1114 may extend outwardly away from the rear surface of the platform 104b adjacent the right and left sides of the platform 104b, respectively. The coupling arms may be coupled the power unit in the mast 102b so that the power unit drives the platform 104b between the lowered and raised positions. In the illustrated example embodiment and right side coupling arm 1112 is longer than the left side coupling arm 1114, and both the right side coupling arm 1112 and the left side coupling arm 1114 extend from the rear surface of the platform 104b at an associated non-90 degree angle (which may be the same angle) to facilitate formation of the angle A1 between the front surface of the mast 102b and the rear surface of the platform 104b.

A boss 1116 may extend outwardly away from the rear surface of the platform 104b for maintaining a desired space between the platform 104b and the mast 102b during movement of the platform 104b. In the illustrated example embodiment, the boss is disposed adjacent the right side coupling arm 1112 and between the right side coupling arm 1112 and the left side coupling arm 1114. In some embodiments, the boss may extend at a substantially 90 degree angle from the rear surface of the platform 104b.

In the illustrated example embodiment, the guide 106 is configured as trapezium with first and second elongate and parallel sides a first end at a right angle to the first and second sides and a guide end at a non-90 degree angle to the first and second sides. The guide end extends in a direction toward the front of the platform 104b from the first side (the side closest to the right side of the platform 104b). The guide end thus provides an angled guide 106 for guiding a cart 1002 rolled onto the platform 104b from the right side toward the front of the platform 104b.

When the cart 1002 is moved to a position between the guide end of the guide 106 and the front of the platform 104b, as shown in FIG. 10D, wheels of the cart 1002 move down to the bottom of the retention ramp 1110 to position the wheels adjacent the left side of the platform 104b. In this position a shelf 1020 on the cart 1002 is positioned beneath a retention extension 1022 extending inwardly toward the base 1102 of the platform 104b from the left side of the sidewall 1104. This captures the cart 1002 between the retention extension 1022 and the retention ramp 1110 with the cart 1002 positioned between the guide end of the guide 106 and the front portion of the side wall 1104.

When the platform 104b is moved from the lowered position shown in FIG. 10C to the raised position shown in FIG. 12, the platform 104b may rotate downwardly to retain the cart 1002 on the platform 104b by force of gravity. In particular, in the lowered position shown in FIG. 10C the base 1102 of the platform 104b is substantially parallel with the floor 1003 on which the lift 100b rests, e.g., due to contact of the platform 104b with the floor 1003. As the platform 104b moves upward, the platform 104b rotates to position the left side of the platform 104b at a position lower than the right side of the platform 104b. This places the base 1102 of the platform 104b at a non-zero angle A2 with respect to the floor 1003, as shown in FIG. 12.

The angle A2 depends on the application, and, in some cases, the dimensions of the of the base 1102 and/or the configuration of the carts/loads to be lifted by the lift 100b. The angle A1 may be any angle that rotates the cart 1002 downwardly away from the open side of the platform 104b (i.e., the right side in the illustrated embodiment) to prevent the cart 1002 from rolling off of the platform 104b through the open side. In some embodiments the angle A1 may nominally be between about 1 degree and 5 degrees.

The platform 104b may be coupled to the mast 102b in a variety of ways to facilitate rotation of the platform 104b relative to the mast 102b and the floor 1003 to achieve the angle A2. In some embodiments, for example, the power unit 904 may be configured to engage the right side coupling arm 1112 before engaging the left side power arm. In this configuration, the right side of the platform 104b raises upwardly prior to the left side of the platform 104b to form the angle A2. When the platform 104b returns to the lowered position, the floor 1003 surface moves the platform 104b back into a substantially parallel position relative to the floor 1003. In some embodiments, the platform 104b may be coupled to the mast 102b using one or more pivot pins that allow rotation of the platform 104b as the platform 104b is moved to the raised position.

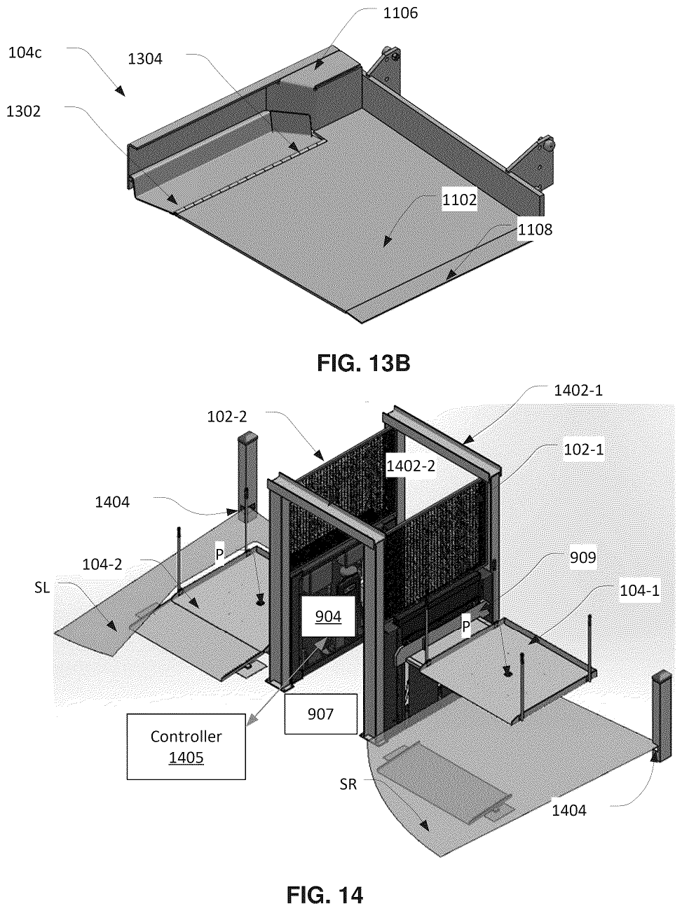

In some embodiments, a platform in a lift consistent with the present disclosure may retain a cart 1002 thereon without rotating. FIGS. 13A and 13B, for example, illustrate another example of a platform 104c useful in a lift consistent with the present disclosure The platform 104c is similar to the platform 104b, but instead includes a hinged door 1302 positioned as the left side of the platform 104c. The door 1302 is coupled to the base 1102 by a hinge 1304 positioned between the right side of the platform 104c and the left side of the platform 104c. When the platform 104c is in the lowered position, contact of the door 1302 with the floor 1003 surface moves the door 1302 upward and substantially parallel with the floor 1003 surface. As the platform 104c is raised, the door 1302 rotates downwardly about the hinge 1304 to until it is restricted by a catch. The wheels of the cart 1002 thus fall into the space adjacent the left side of the platform 104c vacated by the door 1302 to prevent the lift from rolling of the platform 104c from the open side thereof (i.e., the right side in the illustrated embodiment.)

In some embodiments, the power unit 904 may include a known and commercially available electro-hydraulic actuator for raising the platform from the lowered position to the raised position. It has been found that use of an electro-hydraulic actuator in combination with a lift consistent with the present disclosure provides significant advantages.

In some embodiments consistent with the present disclosure, the power 904 unit may advantageously include one or more known electro-hydraulic actuators. In general, an electro-hydraulic actuator operates by converting electrical energy into hydraulic pressure using an electric motor to power a pump, which then pressurizes hydraulic fluid that drives a hydraulic cylinder to produce linear motion; essentially, an electric signal controls the movement of a piston within a cylinder using pressurized oil, allowing for precise control of force and position. Electro-hydraulic actuators can provide significant force in low response times due to the high pressure of hydraulic fluid and precise control of force and position through use of internal or external feedback sensors.

Some embodiments of electro-hydraulic actuators also include a counterbalance valve that allows for controlled retraction of the actuator. An electro-hydraulic actuator counterbalance valve may function by using a pilot pressure signal to control the flow of hydraulic fluid within the actuator, effectively allowing free flow in one direction (extension) while restricting the flow in the opposite direction (retraction) unless a specific pressure threshold is reached, thus preventing uncontrolled descent of a load and maintaining its position even when the actuator is not actively powered; this pressure threshold is typically set based on the load being handled, allowing the valve to adjust its flow rate as needed depending on the load conditions.

The load control provided by an electro-hydraulic actuator has been found to be particularly advantageous in connection lifts consistent with the present disclosure since they can reduce the risk of injury to a user that inadvertently places a limb under the platform when the platform is in the raised position or moving to the raise position. Electro-hydraulic actuators are also useful in establishing safety zones for a lift consistent with the present disclosure.

FIG. 14, for example, illustrates an example of a double sided lift consistent with the present disclosure including two masts 102-1, 102-2 joined at the top thereof by two headers 1402-1, 1402-2. Each mast 102-1, 102-2 has an associated platform 104-1, 104-2, respectively, that is moved from a lowered position to a raised position by an associated power unit 904 housed in the associated mast 102-1, 102-2. In some embodiments, the platforms 104-1, 104-2 may be configured as turntables that are rotatable about central pivot point P. For example, the platforms 104-1, 104-2 may be coupled to the mast 102-1, 102-1 through a drive interface 909 that is fixed to the mast. and the platforms 104-1, 104-2 may be pivotally coupled to the drive interface 909 at the pivot point P. Each power unit 904 may include one or more electro-hydraulic actuators.

In the illustrated example embodiment, safety zones may dynamically adjust depending on the position of the platform associated therewith. Safety zones may be areas around the lift where presence of a user or an object may be detected and the detection may cause the platform 104-1 or 104-2 to hold discontinue movement until the user or object is removed. In FIG. 14, a raised position safety zone SR is established by one or more optical sensors 1404 associated with the first mast 102-1. Output signals from the one or more optical sensors 1404 are coupled to an a controller 1405 through a wired or wireless connection and the controller 1405 provides one or more control signals to the power unit 904. The raised position safety zone SR extends underneath the platform 104-1 from the front of the platform 104-1 to the mast 102-1 and across the width of the platform 104-1 and also extends and around the platform 104-1.

The raised position safety zone SR may protect against injury to a user when the platform is being lowered from the raised position. If a user or object is detected in the raised position safety zone SR, the power unit 904 is signaled by the controller 1405 in response to output signals from the one or more optical sensors 1404 to discontinue movement of the platform 104-1 to the lowered position until the user or object is removed from the raised position safety zone. An electro-hydraulic actuator is particularly advantageous in this configuration since it can reliably hold the load in a raised position, even if power is disconnected.

As shown with respect to the platform 104-2, a lowered position safety zone SL is established by one or more optical sensors 1404 associated with the second mast 102-2. The lowered position safety zone SL extends around the front and left sides of the platform 104-2, without extending around the front of the platform 104-2 where a cart or other container is received onto the platform. The lowered position safety zone SL may protect against injury to a user when the platform 104-2 is being loaded or when moving of the platform is initiated or is in its final stages. If a user or object is detected in the lowered position safety zone SL, the power unit 904 is signaled by the controller 1405 in response to the outputs of the optical sensors 1404 to discontinue movement of the platform 104-2 to the raised position until the user or object is removed from the lowered position safety zone.

The lowered position safety zone SL and the raised position safety zone SR associated with each platform 104-1, 104-2 and mast 102-1, 102-2 may vary dynamically depending on the position of the platform 104-1, 104-2. For example, one or more position sensors 907, e.g., Hall Effect sensors, optical sensors, resistive sensors, etc., may detect when the platform 104-1, 104-2 is in the lowered position and signal the optical sensors 1404, e.g., via the controller 1405, to generate a lowered position safety zone SL around the platform. The one or more position sensors 907 may also detect when the platform 104-1, 104-2 has been raised to threshold height, e.g., a predetermined height, and signal the optical sensors 1404 to generate a raised position safety zone SR with respect to the platform 104-1, 104-2. The position sensors may be coupled to the mast 102-1, 102-2. In some embodiments, an electro-hydraulic actuator is particularly advantageous in this configuration since the electro-hydraulic actuator may include integral position sensors 907 that can be used to control the dynamic safety zones.

According to the present disclosure, there is thus provided a material handling lift including: a platform having a first side for receiving a cart on a base of the platform and second side opposite the first side; and a vertical mast including a power unit configured to drive the platform to a raised position relative to the mast and lower the platform to a lowered position relative to the mast, the platform being coupled to the mast with the base of the platform substantially parallel with a floor surface supporting the mast when the platform is in the lowered position, and the platform being coupled to the mast to allow the platform to rotate downwardly toward the second side to position the base of the platform at a non-zero angle relative to the floor surface as the platform is raised to the raised position to thereby retain the cart on the base by force of gravity.

In some embodiments, the angle is nominally between about 1 degree and 5 degrees. In some embodiments, the platform is coupled to the mast with a front surface of the mast disposed at a non-zero second angle relative to a rear surface of the platform. In some embodiments, the second angle is nominally between about 1 degree and 15 degrees.

In some embodiments, the platform includes a first coupling arm coupled to the mast and extending outwardly from a rear surface of the platform adjacent the first side, and a second coupling arm coupled to the mast and extending outwardly from the rear surface of the platform adjacent the second side. In some embodiments, the first coupling arm is longer than the second coupling arm. In some embodiments, the power unit is configured to engage the first coupling arm before engaging the second coupling arm as the power unit drives the platform to the raised position.

In some embodiments, the platform further includes a retention ramp extending downwardly relative to the base toward the second side to allow a wheel of the cart to move downward on the retention ramp toward the second side. In some embodiments, the platform further includes a retention extension adjacent the second side and extending inwardly toward the base and configured to be positioned above a shelf of the cart when the wheel of the cart is disposed on the retention ramp.

In some embodiments, the platform further includes an angled guide for guiding the cart toward the second side and a front of the platform. In some embodiments, the platform includes a door adjacent the second side and coupled to the base by a hinge, the door being configured to open as the platform is driven to the raised position to thereby capture a wheel of the cart. In some embodiments, the platform includes at least one wheel receptacle in a top surface of the platform for receiving a wheel of the cart to releasably restrict the wheel from rolling while the platform is driven to the raised position.

According to another aspect of the present disclosure, there is provided a material handling lift including: a platform having a first side for receiving a cart on a base of the platform and second side opposite the first side; and a vertical mast including a power unit configured to drive the platform to a raised position relative to the mast and lower the platform to a lowered position relative to the mast, the platform being coupled to the mast with the base of the platform substantially parallel with a floor surface supporting the mast when the platform is in the lowered position, the platform being coupled to the mast to allow the platform to rotate downwardly toward the second side to position the base of the platform at a non-zero angle relative to the floor surface as the platform is raised to the raised position to thereby retain the cart on the base by force of gravity, and the platform including a first coupling arm coupled to the mast and extending outwardly from a rear surface of the platform adjacent the first side, and a second coupling arm coupled to the mast and extending outwardly from the rear surface of the platform adjacent the second side, the first coupling arm being longer than the second coupling arm and the platform being coupled to the mast with a front surface of the mast disposed at a non-zero second angle relative to a rear surface of the platform

In some embodiments, the angle is nominally between about 1 degree and 5 degrees. In some embodiments the second angle is nominally between about 1 degree and 15 degrees. In some embodiments, the power unit is configured to engage the first coupling arm before engaging the second coupling arm as the power unit drives the platform to the raised position.

In some embodiments, the platform further includes a retention ramp extending downwardly relative to the base toward the second side to allow a wheel of the cart to move downward on the retention ramp toward the second side. In some embodiments, the platform further includes a retention extension adjacent the second side and extending inwardly toward the base and configured to be positioned above a shelf of the cart when the wheel of the cart is disposed on the retention ramp.

In some embodiments, the platform includes a door adjacent the second side and coupled to the base by a hinge, the door being configured to open as the platform is driven to the raised position to thereby capture a wheel of the cart. In some embodiments, the platform includes at least one wheel receptacle in a top surface of the platform for receiving a wheel of the cart to releasably restrict the wheel from rolling while the platform is driven to the raised position.

According to another aspect of the disclosure, there is provided a material handling lift including: a platform having a first side for receiving a cart on a base of the platform and second side opposite the first side; and a vertical mast including a power unit configured to drive the platform to a raised position relative to the mast and lower the platform to a lowered position relative to the mast, the platform being coupled to the mast with a front surface of the mast disposed at a non-zero angle relative to a rear surface of the platform. In some embodiments, the angle is nominally between about 1 degree and 15 degrees.

In some embodiments, the platform includes a first coupling arm coupled to the mast and extending outwardly from a rear surface of the platform adjacent the first side, and a second coupling arm coupled to the mast and extending outwardly from the rear surface of the platform adjacent the second side. In some embodiments, the first coupling arm is longer than the second coupling arm. In some embodiments, the power unit is configured to engage the first coupling arm before engaging the second coupling arm as the power unit drives the platform to the raised position.

In some embodiments, the platform further includes a retention ramp extending downwardly relative to the base toward the second side to allow a wheel of the cart to move downward on the retention ramp toward the second side. In some embodiments, the platform further includes a retention extension adjacent the second side and extending inwardly toward the base and configured to be positioned above a shelf of the cart when the wheel of the cart is disposed on the retention ramp. In some embodiments, the platform further includes an angled guide for guiding the cart toward the second side and a front of the platform.

In some embodiments, the platform includes a door adjacent the second side and coupled to the base by a hinge, the door being configured to open as the platform is driven to the raised position to thereby capture a wheel of the cart. In some embodiments, the platform includes at least one wheel receptacle in a top surface of the platform for receiving a wheel of the cart to releasably restrict the wheel from rolling while the platform is driven to the raised position.

According to another aspect of the present disclosure, there is provided a material handling lift including: at least one platform; at least one vertical mast including a power unit configured to drive the platform to a raised position relative to the mast and lower the platform to a lowered position relative to the mast; at least one optical sensor dynamically defining a first safety zone when the platform is in the lowered position and a second safety zone when the platform is in the raised position, the first safety zone extending under and around the platform and the second safety zone not extending under the platform and not extending around a side of the platform for receiving a container; and a controller for receiving a control signal from the at least one optical sensor when an object is in the first or second safety zone and providing an output to the power unit to halt movement of the platform toward the lowered position or the raised position.

In some embodiments, the power unit includes an electro-hydraulic actuator and the output is configured to halt movement of the platform when the platform is in the raised position. In some embodiments, the lift further includes at least one position sensor configured to detect a height of the platform above a floor surface and provide an output to the one or more optical sensors representative of the height to cause the one or more optical sensors to define the first safety zone when the platform reaches a threshold height and define the second safety zone when the platform is below the threshold height. In some embodiments, the at least one position sensor is integral with the electro-hydraulic actuator. In some embodiments, the least one platform is coupled to the mast for rotation about a pivot point.

According to another aspect of the present disclosure, there is provided a material handling lift including: a mast; a platform coupled to the mast; a power unit configured to drive the platform along the mast to a raised position and lower the platform to a lowered position; and at least one wheel receptacle in a top surface of the platform for receiving a wheel of a roller cart to releasably restrict the wheel from rolling while the platform is driven to the raised position.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein.

It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The term “coupled” as used herein refers to any connection, coupling, link. Components described herein as “coupled” may be directly coupled to one another or may be indirectly coupled through intermediate components.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

The terms “comprising”, “including” and “having” are intended to be inclusive and mean that there may be additional elements other than the listed elements.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Spatially relative terms, such as “beneath,” below,” upper,” “lower,” “above” and the like may be used herein for ease of description to describe one element or feature's relationship to another element(s) or feature(s) as illustrated in the drawings. These spatially relative terms are intended to encompass different orientations of the device in use or operation in addition to the orientation shown in the drawings. For example, if the device in the drawings is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

As used herein, use of the term “nominal” or “nominally” when referring to an amount means a designated or theoretical amount that may vary from the actual amount.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A material handling lift comprising:
a platform having a first side for receiving a cart on a base of the platform and second side opposite the first side; and
a vertical mast comprising a power unit configured to drive the platform to a raised position relative to the mast and lower the platform to a lowered position relative to the mast,
the platform being coupled to the mast with the base of the platform substantially parallel with a floor surface supporting the mast when the platform is in the lowered position, and
the platform being coupled to the mast to allow the platform to rotate downwardly toward the second side to position the base of the platform at a non-zero angle relative to the floor surface as the platform is raised to the raised position to thereby retain the cart on the base by force of gravity.

2. The material handling lift of claim 1, wherein the angle is nominally between about 1 degree and 5 degrees.

3. The material handling lift of claim 1, wherein the platform is coupled to the mast with a front surface of the mast disposed at a non-zero second angle relative to a rear surface of the platform.

4. The material handling lift of claim 3, wherein the second angle is nominally between about 1 degree and 15 degrees.

5. The material handling lift of claim 1, wherein the platform comprises a first coupling arm coupled to the mast and extending outwardly from a rear surface of the platform adjacent the first side, and a second coupling arm coupled to the mast and extending outwardly from the rear surface of the platform adjacent the second side.

6. The material handling lift of claim 5, wherein the first coupling arm is longer than the second coupling arm.

7. The material handling lift of claim 5, wherein the power unit is configured to engage the first coupling arm before engaging the second coupling arm as the power unit drives the platform to the raised position.

8. The material handling lift of claim 1, wherein the platform further comprises a retention ramp extending downwardly relative to the base toward the second side to allow a wheel of the cart to move downward on the retention ramp toward the second side.

9. The material handling lift of claim 8, wherein the platform further comprises a retention extension adjacent the second side and extending inwardly toward the base and configured to be positioned above a shelf of the cart when the wheel of the cart is disposed on the retention ramp.

10. The material handling lift of claim 1, wherein the platform further comprises an angled guide for guiding the cart toward the second side and a front of the platform.

11. The material handling lift of claim 1, wherein the platform comprises a door adjacent the second side and coupled to the base by a hinge, the door being configured to open as the platform is driven to the raised position to thereby capture a wheel of the cart.

12. The material handling lift of claim 1, wherein the platform comprises at least one wheel receptacle in a top surface of the platform for receiving a wheel of the cart to releasably restrict the wheel from rolling while the platform is driven to the raised position.

13. A material handling lift comprising:
a platform having a first side for receiving a cart on a base of the platform and second side opposite the first side; and
a vertical mast comprising a power unit configured to drive the platform to a raised position relative to the mast and lower the platform to a lowered position relative to the mast,
the platform being coupled to the mast with the base of the platform substantially parallel with a floor surface supporting the mast when the platform is in the lowered position,
the platform being coupled to the mast to allow the platform to rotate downwardly toward the second side to position the base of the platform at a non-zero angle relative to the floor surface as the platform is raised to the raised position to thereby retain the cart on the base by force of gravity, and
the platform comprising a first coupling arm coupled to the mast and extending outwardly from a rear surface of the platform adjacent the first side, and a second coupling arm coupled to the mast and extending outwardly from the rear surface of the platform adjacent the second side, the first coupling arm being longer than the second coupling arm and the platform being coupled to the mast with a front surface of the mast disposed at a non-zero second angle relative to a rear surface of the platform.

14. The material handling lift of claim 13, wherein the angle is nominally between about 1 degree and 5 degrees.

15. The material handling lift of claim 13, wherein the second angle is nominally between about 1 degree and 15 degrees.

16. The material handling lift of claim 13, wherein the power unit is configured to engage the first coupling arm before engaging the second coupling arm as the power unit drives the platform to the raised position.

17. The material handling lift of claim 13, wherein the platform further comprises a retention ramp extending downwardly relative to the base toward the second side to allow a wheel of the cart to move downward on the retention ramp toward the second side.

18. The material handling lift of claim 17, wherein the platform further comprises a retention extension adjacent the second side and extending inwardly toward the base and configured to be positioned above a shelf of the cart when the wheel of the cart is disposed on the retention ramp.

19. The material handling lift of claim 13, wherein the platform comprises a door adjacent the second side and coupled to the base by a hinge, the door being configured to open as the platform is driven to the raised position to thereby capture a wheel of the cart.

20. The material handling lift of claim 13, wherein the platform comprises at least one wheel receptacle in a top surface of the platform for receiving a wheel of the cart to releasably restrict the wheel from rolling while the platform is driven to the raised position.
